(19) United States
(12) Patent Application Publication
(10) Pub. No.: US 2008/0148951 A1
(43) Pub. Date: Jun. 26, 2008

(54) Fluid Pumping System

(76) Inventor: Valentin Alvarez Velazquez, Logrono (ES)

Correspondence Address: Quinn Emanuel Urquhart Oliver & Hedges, LLP;Koda/Androlia, 865 S. Figueroa Street, 10th Floor, Los Angeles, CA, 90017, US

(21) Appl. No.: 11/885,620

(22) PCT Filed: Feb. 20, 2006
(86) PCT No.: PCT/ES06/00075

§ 371 Date: Aug. 31, 2007

(30) Foreign Application Priority Data
Mar. 1, 2005 (ES) P 200500468

(51) Int. Cl. C12G 1/02

(52) U.S. Cl. 99/277

(57) ABSTRACT

The invention relates to a fluid-pumping system comprising at least two interconnected containers (1,2) and extraction and pumping means (5) for transferring the fluid content, in the form of water or air, from one container to another in a uniform manner. In addition, each of the containers (1,2) is equipped with an elastic membrane (3,4) which divides same into chambers (1a, 1b) and (2a, 2b). The wine product is kept separate form the water or air in each of the chambers, such that as one chamber (1a or 2a) in a container is being filled with a fluid in the form of water o air, one of the chambers (2a or 1a) in the other container is being emptied until a point at which the process is reversed, said exchange taking place in a uniform, continuous manner without interruption in the manner of a closed circuit.

### OBJECT OF THE INVENTION

The present patent application refers to a fluid pumping system that incorporates outstanding innovations and advantages as compared to the systems and procedures currently used, for instance, in the wine-making field.

More specifically, it refers to a pumping system for fluids intended, for example, for consumption, which comprises at least two interconnected storage tanks.

### BACKGROUND OF THE INVENTION

The decanting or “separation” operation is known in the wine-making field and, more specifically, after the so-called “tumultuous fermentation” process, lasting for a period of 10 to 20 days. This operation consists in the passage of the wine from one storage tank to the other making solid particles sink to the bottom of the tank, either as a result of cold application or of the cold winter temperatures registered inside the wineries, the upper part of the wine content subsequently going through to another container. This operation is conducted to oxygenate the content and prevent the sediments from decomposing, which would alter the wine qualities.

In order to conduct the decanting operation, wine makers use conventional aspiration pumps to automate the process.

Nevertheless, the use of the pump causes strong stirring as a result of the violent content fall, as well as of the content circulation through the pipes of the premises, thus directly affecting the quality of the wine, such as, for example, its taste and colour properties.

### DESCRIPTION OF THE INVENTION

The present invention has been developed with the aim of providing a system for the pumping process that would solve the above-mentioned drawbacks, additionally providing further advantages which shall become evident from the description included below.

The fluid pumping system of the present invention, particularly intended for products from the wine-making industry, comprises at least two interconnected storage tanks, and is characterised by the fact that it comprises extraction and impulse means to conduct the passage of fluid content, said fluid content being water or air, from one storage tank to another in a uniform fashion through a pipe, each storage tank including an elastic membrane, dividing said tanks into two chambers respectively, maintaining the wine product separated from the water or air in each chamber, so that as one chamber or one of the tanks is being filled with fluid, either water or air, one of the chambers or the other tank is emptied until the process is reversed, said exchange being uniform and uninterrupted.

As a result of these characteristics, an improved system is obtained wherein the liquid content, such as a wine product, is handled more delicately in order to maintain a constant degree of quality during the whole pumping process, thus enabling the pumping of a larger quantity of wine.

Preferably, the extraction and impulse means consist in a turbine when the fluid to be passed is air. On the other hand, the extraction and impulse means consist in a pump when the content to be passed is water.

Other features and advantages of the fluid pumping system of the present invention shall become evident from the description of a preferred but not exclusive embodiment, which is illustrated as a non-limiting example in the drawings below, wherein:

### BRIEF DESCRIPTION OF THE DRAWINGS

FIG. 1.—Schematic vertical view of an installation intended to work with the pumping system of the invention in a first stage of the process described;

FIG. 2.—Schematic view of the pumping system in a second stage;

FIG. 3.—Schematic view of the pumping system in a third stage;

FIG. 4.—Schematic view of the pumping system in a fourth stage;

FIG. 5.—Schematic view of the pumping system of the invention in a last stage.

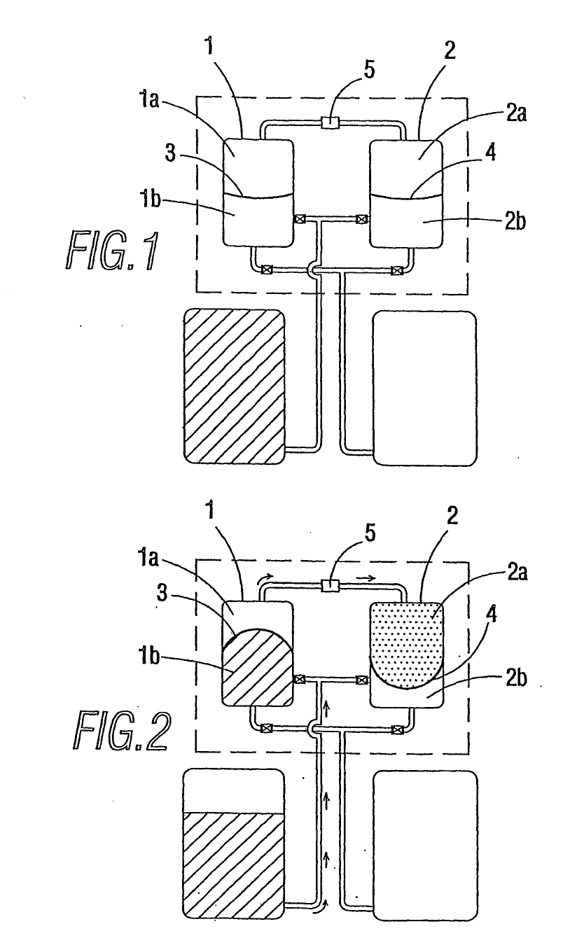

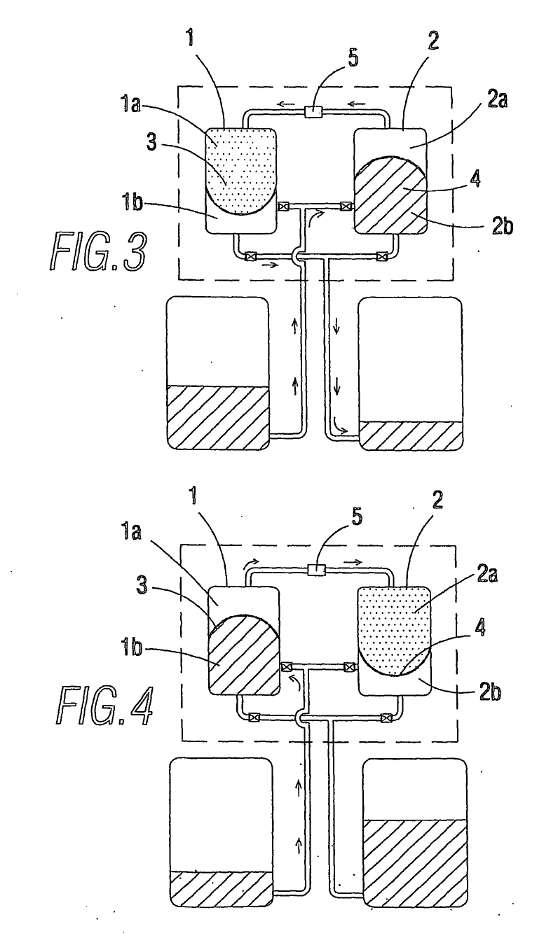

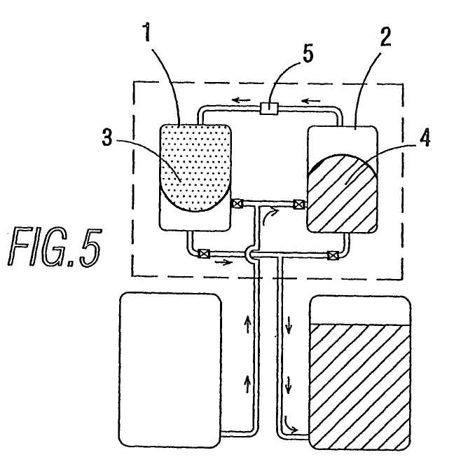

### DESCRIPTION OF A PREFERRED EMBODIMENT

As shown in the figures, the fluid pumping system, particularly intended for products from the wine-making industry, described herein comprises at least two interconnected storage tanks (1, 2), with extraction and impulse means (5) to conduct the passage of fluid content, said fluid content being water or air, from one tank to the other in a uniform fashion through a pipe, each tank including an elastic membrane (3, 4) maintaining the wine product separate from the water or air, so that as a tank is being filled with fluid, the other is emptied until the process is reversed, said exchange being uniform and uninterrupted. Therefore, both tanks (1) and (2) are divided into chambers (1a, 1b) and (2a, 2b) respectively and chambers (1a) and (2a) define a closed circuit.

The extraction and impulse means (5) used consist in a turbine when the fluid to be passed is air, or a pump when the fluid to be passed is water either in the direction of chamber (1a) or chamber (2a) or vice versa.

The storage tanks represented in the lower part of the figures correspond to the wine supply tank and to an empty tank.

In the figure attached the pumping system of the invention has been marked into a rectangle with a broken line, along with a series of electrical valves arranged in the different connections.

In the different figures used to facilitate the understanding of the object of this invention, arrows have been used to indicate the direction of the fluids, as well as striped areas, so that: the striped areas with equidistant and sloping lines represent the element to be pumped, for example, wine, whereas the dotted area indicates only the presence of the fluid, that is water or air.

The details, the shapes, the dimensions and other accessory elements, as well as the materials used in the manufacture of the fluid pumping system of the invention may be conveniently replaced by others which are technically equivalent and respond to the essence of the invention and the field defined by the claims included below.

1. A “fluid pumping system”, particularly intended for products from the wine-making industry, which comprises at least two interconnected storage tanks (1, 2), characterised by the fact that it comprises extraction and impulse means (5) to conduct the passage of fluid content, said content being water or air, from one tank to the other in a uniform fashion through a pipe, each of the tanks (1, 2) including an elastic membrane (3, 4), dividing said tanks (1, 2) into chambers (1a, 1b) and (2a, 2b) respectively, maintaining the wine product separate from the water or air in each chamber so that as one chamber (1a) or (2a) of a tank is being filled with fluid (water or air), one of the chambers (2a) or (1a) of the other tank is emptied until the process is reversed, said exchange being uniform, continuous and uninterrupted.

2. A “fluid pumping system” according to claim 1, wherein the extraction and impulse means (5) consist in a turbine when the fluid to be passed is air.

3. A “fluid pumping system” according to claim 1, wherein the extraction and impulse means (5) consist in a pump when the fluid to be passed is water.
